(19) United States
(12) Patent Application Publication
(10) Pub. No.: US 2017/0238311 A1
(43) Pub. Date: Aug. 17, 2017

(54) Synchronous Licensed Assisted Access

(71) Applicant: Nokia Technologies Oy, Espoo (FI)

(72) Inventors: Kari Hooli, Oulu (FI); Klaus Hugl, Wien (AT); Esa Tiirola, Kempele (FI); Timo Lunttila, Espoo (FI)

(21) Appl. No.: 15/329,417

(22) PCT Filed: Sep. 26, 2014
(86) PCT No.: PCT/IB2014/064878

§ 371 Date: Jan. 26, 2017

(51) Int. Cl. H04W 72/04; H04W 74/08; H04W 16/14

(52) U.S. Cl. CPC H04W 72/0446; H04W 16/14; H04W 74/0808; H04W 72/042

(57) ABSTRACT

A method including forming a reservation signal including a first part and a second part; and transmitting the reservation signal by a base station in a first cell on a channel during a portion of a first subframe until start of a next following subframe. The first part is configured to reserve the channel between the base station and a user equipment (UE). The second part includes downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

### BACKGROUND

1. Technical Field

The exemplary and non-limiting embodiments relate generally to wireless communications and, more particularly, to radio communications.

2. Brief Description of Prior Developments

Listen Before Talk (LBT) (or sometimes called Listen Before Transmit) is a technique used whereby a radio transmitter first senses its radio environment before it starts a transmission. LBT can be used by a radio device to find a free radio channel or resource to operate on.

### SUMMARY

The following summary is merely intended to be exemplary. The summary is not intended to limit the scope of the claims.

In accordance with one aspect, an example method comprising forming a reservation signal comprising a first part and a second part; and transmitting the reservation signal by a base station in a first cell on a channel during a portion of a first subframe until start of a next following subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example apparatus comprises at least one processor; and at least one non-transitory memory including computer program code, the at least one memory and the computer program code configured to, with the at least one processor, cause the apparatus to: form a reservation signal comprising a first part and a second part; and transmit the reservation signal in a first cell on a channel during a portion of a first subframe until start of a next following subframe, where the first part is configured to reserve the channel between the apparatus and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example apparatus is provided in a non-transitory program storage device readable by a machine, tangibly embodying a program of instructions executable by the machine for performing operations, the operations comprising: forming a reservation signal comprising a first part and a second part; and transmitting the reservation signal by a base station in a first cell on a channel during a portion of a first subframe until start of a next subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example method comprises, in a user equipment (UE) having communication in a first cell using a licensed spectrum, receiving a reservation signal in a second cell on a channel during a portion of a first subframe until start of a next following subframe, where the reservation signal comprises a first part and a second part; and using the second part of the reservation signal by the UE, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example method comprises receiving an assignment for a Physical Downlink Shared Channel (PDSCH) on a second part of a reservation signal, where the reservation signal comprises a first part and the second part, where the second part comprises downlink Orthogonal Frequency Division Multiplexing (OFDM) symbols carrying Physical Downlink Shared Channel (PDSCH) and at least one of Demodulation Reference Signal (DMRS), Cell Specific Reference Signal (CRS), Physical Downlink Control Channel (PDCCH), or a same Transport Block (TB) as a PDSCH on a next following subframe; and receiving PDSCH on the second part of the reservation signal during a portion of a first subframe until start of a next following subframe, where the portion is less than the entire first subframe.

In accordance with another aspect, an example apparatus comprises at least one processor; and at least one non-transitory memory including computer program code, the at least one memory and the computer program code configured to, with the at least one processor, cause the apparatus to: with the apparatus having communication in a first cell using a licensed spectrum, receive a reservation signal in a second cell on a channel during a portion of a first subframe until start of a next following subframe, where the reservation signal comprises a first part and a second part; and use the second part of the reservation signal by the apparatus, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example apparatus is provided in a non-transitory program storage device readable by a machine, tangibly embodying a program of instructions executable by the machine for performing operations, the operations comprising: in a user equipment (UE) having communication in a first cell using a licensed spectrum, receiving a reservation signal on a channel in a second cell, where the reservation signal comprises a first part and a second part; and using the second part of the reservation signal by the UE, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDSCH), or a same Transport Block (TB) as a PDSCH on the next following subframe, and the portion is less than the entire first subframe.

In accordance with another aspect, an example apparatus is provided comprising: means for forming a reservation signal comprising a first part and a second part; and means for transmitting the reservation signal by a base station in a first cell on a channel during a portion of a first subframe until start of a next subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

In accordance with another aspect, an example apparatus is provided comprising, in a user equipment (UE) having communication in a user equipment (UE) having communication in a first cell using a licensed spectrum, means for receiving a reservation signal in a second cell on a channel during a portion of a first subframe until start of a next following subframe, where the reservation signal comprises a first part and a second part; and means for using the second part of the reservation signal by the UE , where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

### BRIEF DESCRIPTION OF THE DRAWINGS

The foregoing aspects and other features are explained in the following description, taken in connection with the accompanying drawings, wherein:

FIG. 1 is a diagram illustrating an example of an overall architecture of a E-UTRAN (evolved UMTS Terrestrial Radio Access) system (an air interface of 3GPP's Long Term Evolution (LTE) upgrade path for mobile networks);

FIG. 2 is a diagram illustrating an example of a User Equipment (UE) in partially overlapping cells;

FIGS. 3A and 3B and 3C are diagrams illustrating examples of a reservation signal;

FIG. 4 is an example of a method for channel occupancy;

FIG. 5 is a diagram illustrating some components of the wireless system shown in FIGS. 1 and 2;

FIG. 6 is a diagram illustrating an example method; and

FIG. 7 is a diagram illustrating an example method.

### DETAILED DESCRIPTION OF EMBODIMENTS

The following abbreviations that may be found in the specification and/or the drawing figures are defined as follows:
3GPP Third Generation Partnership Program
AP Access Point
BB Baseband
CC Component Carrier
CCA Clear Channel Assignment
CRC Cyclic Redundancy Check
CRS Cell Specific Reference Signal
CRW Channel Reservation Window
CSI Channel State Information
CSI-RS Channel State Information Reference Signal
CSS Common Search Space
DCI Downlink Control Information
DL Downlink
DMRS Demodulation Reference Signal
DS Discovery Signal
DTX Discontinuous Transmission
DwPTS Downlink Pilot Time Slot
e.i.r.p. equivalent isotropically radiated power
eIMTA Enhanced Interference Mitigation and Traffic Adaptation (the name of the 3GPP WI targeting to flexible UL/DL adaptation for TD-LTE)
eNB/eNodeB enhanced Node B (base station according to LTE terminology)
EPC Enhanced Packet Core
EPDCCH Enhanced PDCCH
FDD Frequency Division Duplex
GP Guard Period
ID Identity
ISM Industrial, Scientific and Medical
LAA License-Assisted Access
LBT Listen Before Talk
LTE Long Term Evolution
NCT New Carrier Type
OFDM Orthogonal Frequency Division Multiplexing
OFDMA Orthogonal Frequency Division Multiple Access
PCell Primary Cell
PDCCH Physical Downlink Control CHannel
PDSCH Physical Downlink Shared CHannel
PLMN Public Land Mobile Network
PRB Physical Resource Block
PSS Primary Synchronization Signal
RAN Radio Access Network
Rel Release
RNTI Radio Network Temporary Identifier
RRM Radio Resource Management
SCell Secondary Cell
SCS Short Control Signalling
SSS Secondary Synchronization Signal
SDL Supplemental DL
TB Transport Block
TD/TDD Time Division duplex
TL Threshold Level
UE User Equipment
UL Uplink
UpPTS Uplink Pilot Time Slot
X2 X2 is an interface used to communication between eNBs

Features as described below facilitate efficient implementation of Listen Before Talk (LBT) while allowing for subframe and symbol synchronized operation of a Long Term Evolution License-Assisted Access (LTE LAA) carrier. Specifically, features as described herein may be used with a Load Based Equipment (LBE) operation.

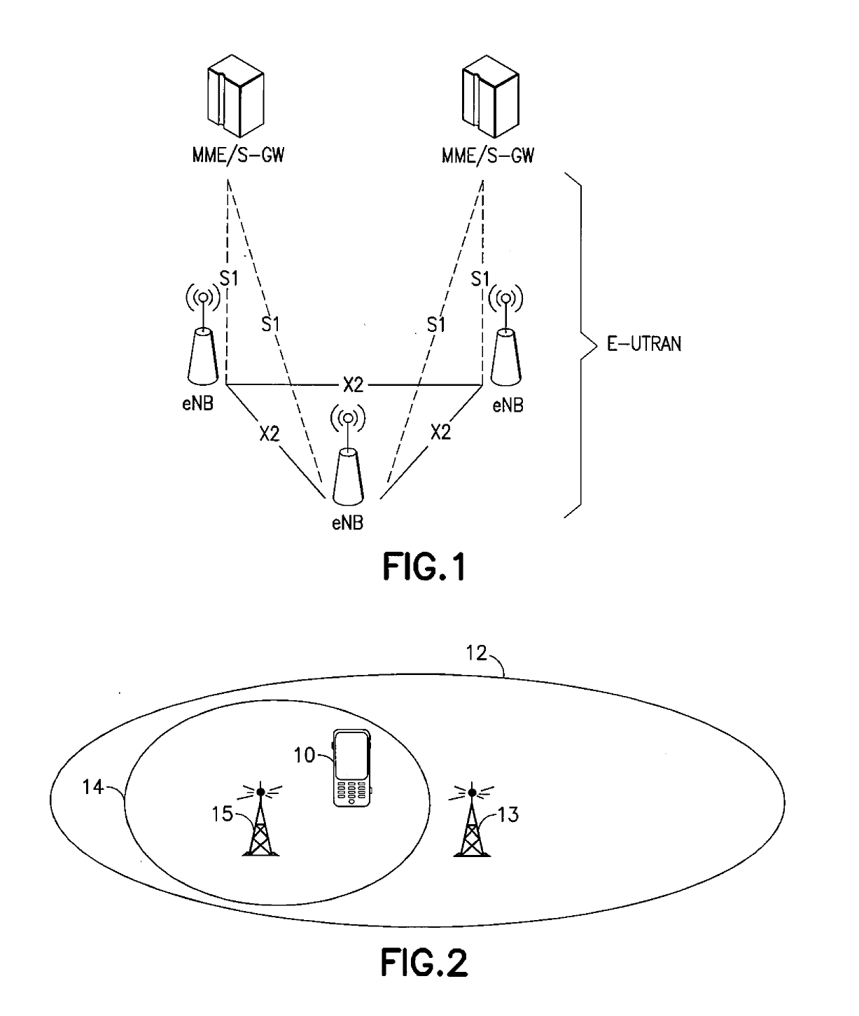

FIG. 1 shows an example of overall architecture of an E-UTRAN system. The E-UTRAN system includes eNBs, providing an E-UTRAN user plane (PDCP/RLC/MAC/PHY) and control plane (RRC) protocol terminations towards the UE (not shown in FIG. 1). The eNBs are interconnected with each other by means of an X2 interface. The eNBs are also connected by means of a S1 interface to an EPC (Enhanced Packet Core), more specifically to a MME (Mobility Management Entity) by means of a S1 MME interface and to a Serving Gateway (S-GW) by means of a S1 interface. The S1 interface supports a many-to-many relationship between MMEs/S-GW and eNBs.

Referring also to FIG. 2, a UE 10 may be connected to more than one cell at a same time. In this example the UE 10 is connected to a PCell 12 having a base station 13 (such as an eNB for example) and a SCell having a base station 15 (such as an eNB or WiFi Access Point for example). The two cells 12, 14 are, thus, at least partially overlapping. The PCell may operate on a licensed band and the SCell on may operate on an unlicensed band. The PCell may be either a FDD cell or TDD cell for example. For simplicity, there are just one PCell and one SCell depicted in the scenario shown in FIG. 2. In other alternate examples any number of cells (PCell and SCell) operating on licensed and/or unlicensed band(s) may be provided to work together for a suitable Carrier Aggregation (CA). In one type of example embodiment the PCell and SCell may be co-located.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Features as described herein may be used in relation to an LTE-Advanced system. More specifically, features as described herein may be used on LTE operation in an unlicensed spectrum also known as Licensed-Assisted Access (LAA). The LTE LAA operation may be based on LTE Carrier Aggregation (CA). Thus, a CA primary cell (PCell) may remain on a licensed band while a secondary cell (SCell) may be on an unlicensed spectrum. Licensed-Assisted Carrier Aggregation operation may be used to aggregate a primary cell, which uses a licensed spectrum, with an at least partially overlapping secondary cell, which uses an unlicensed spectrum. In one type of example embodiment the carrier aggregation principle may assume LTE Rel-10/11/12 Carrier Aggregation scenario with co-located cells and/or non-collocated cells connected with (close to) ideal backhaul. Alternatively, in another type of example embodiment the carrier aggregation principle may assume Rel-12 Small Cell or Dual Connectivity scenario with non-collocated cells (unlicensed and licensed) and (close to) ideal or non-ideal backhaul between them. Use of the unlicensed spectrum may deliver information and guaranteed Quality of Service, to opportunistically boost data rate. The secondary cell may be used for supplemental downlink capacity only, or both downlink and uplink capacity.

The LTE LAA may apply a listen before talk (LBT) procedure, such as based on European regulatory rules defined for 5 GHz ISM band for example. In one example embodiment, the LTE LBT procedure may fulfill the European regulatory rules defined for load based equipment. It may also fulfill other regulatory rules applying a LBT procedure, such as regional regulatory rules for example. Features as described herein may be used to reduce the overhead introduced by LBT operation in the LTE LAA context.

Different regions have different regulatory requirements for unlicensed band operation. For example, 3GPP TDoc RP-140054 (“Review of Regulatory Requirements for Unlicensed Spectrum”) summarizes some of these different regulatory requirements for unlicensed band operation. Despite the regulatory rules, LTE has not yet been deployed in an unlicensed spectrum.

In Europe, for example, regulations mandate the equipment operating on unlicensed spectrum to implement LBT by performing Clear Channel Assessment (CCA) before starting a transmission; to verify that the operating channel is not occupied. ETSI document EN 301 893 defines European regulatory requirements unlicensed band on 5 GHz band. It defines two of modes of operation: Frame Based Equipment (FBE), and Load Based Equipment (LBE). The key properties and the differences between these options can be summarized as described below.

### Frame Based Equipment

Frame based equipment is the equipment where the transmit/receive structure is not directly demand-driven, but has fixed timing. The corresponding European regulatory rules are defined in ETSI document EN 301 893 and can be summarized as follows:
LBT/CCA is performed periodically at predefined time instances according to a predetermined frame structure:
   The periodicity (Fixed Frame Period)=channel occupancy time+idle period
If the equipment finds the Operating Channel(s) to be clear, it may transmit immediately:
   The total time during which equipment is allowed to have transmissions on a given channel without re-evaluating the availability of that channel, is defined as the Channel Occupancy Time.

If the equipment finds an Operating Channel occupied, it shall not transmit on that channel during the next Fixed Frame Period.

### Load Based Equipment

Unlike for FBE, Load based equipment is not restricted to perform LBT/CCA according to a frame structure. Instead, LBE may perform LBT (CCA) whenever it has data to transmit. The key points can be summarized as follows:
Before a transmission (or a burst of transmissions) on an Operating Channel, the equipment performs a Clear Channel Assessment (CCA) check using “energy detect”.
If the equipment finds the Operating Channel(s) to be clear, it may transmit immediately.
   The total time that an equipment makes use of an Operating Channel is the Maximum Channel Occupancy Time which shall be less than (13/32)×q milliseconds, where q={4 . . . 32}. (For example, when q=32, the Maximum Channel Occupancy Time=13 milliseconds).
If the equipment finds an Operating Channel occupied, it does not transmit in that channel.
   The equipment performs an Extended CCA check in which the Operating Channel(s) is/are observed for the duration of a random factor N multiplied by the CCA observation time.
   N defines the number of clear idle slots resulting in a total Idle Period that need to be observed before initiation of the transmission.
   The value of N is randomly selected in the range l . . . q every time an Extended CCA is required and the value may be stored in a counter.
   The counter is decremented every time a CCA slot is considered to be “unoccupied”.
   When the counter reaches zero, the equipment may transmit.

In the example shown in FIG. 2, the SCell 14 may provide the LTE LAA carrier for the UE, where the UE is connected to the PCell 12 in the licensed spectrum. Features as described herein may provide the beneficial result for a LTE LAA carrier in the SCell 14 to operate in a synchronous manner relative to a channel(s) in the PCell 12. The UE may remain synchronized to the DL carrier of the LTE LAA substantially all the time. With features as described herein a reservation signal from the SCell base station 15 to the UE 10 may be used to allow subsequent reference signals to be used for synchronization.

With features as described herein, downlink (DL) reference signals, used for time/frequency tracking, for example, Cell Specific Reference Signal (CRS), as well as signals required for synchronization, for example Primary Synchronization Signal (PSS) and Secondary Synchronization Signal (SSS)), may be transmitted reasonably frequently to the UE from the SCell base station 15. The UE 10 might, therefore, based on the regular reception of these signals used for synchronization, stay synchronized with the SCell base station 15 substantially all the time. Staying synchronized allows for a very dynamic channel access, in an order of 1 ms for example, but at a price of periodic transmission of the reference signals. Existing LTE and LTE-Advanced solutions, for example carrier aggregation procedures, measurements, scheduling and HARQ feedback timing, can be efficiently used if the LTE LAA SCell 14 maintains subframe synchronization with the LTE PCell 12. There can be a time difference up to about 30 microseconds (μs) between LTE-Advanced CA cells. The time difference is expected to be stable and to change mainly due to UE mobility.

LBT/CCA procedure for LBE, as described in ETSI document for example, is inherently asynchronous. Also the LBT/CCA time scale, such as a multiple of 20 μs (or any other value allowed and/or selected), is typically not well aligned with LTE subframe and symbol time durations. Features as described herein provide a solution in order to efficiently embed LBE LBT/CCA procedures into LTE subframe structure; thereby maintaining LTE LAA SCell 14 synchronism with a LTE PCell. Similarly, the provided solution can be used together with LBT requirements of other global regions as well.

After a channel becomes available, as determined by a LBT procedure for example, an eNB would normally need to wait until a start of a next subframe before sending a transmission in order to provide synchronization with communications in a LTE LAA operation and in LTE-Advanced Carrier Aggregation (CA) over LTE LAA SCell/SCells, other SCells and PCell. In other words, an eNB cannot change the start of the next subframe at the time when the LBT procedure determines a channel to be available while keeping subframe timing aligned between the LTE LAA SCell and the other carrier aggregated LTE-Advanced cells. Further, UE 10 maintaining synchronization with the LTE LAA SCell based on the regular reception of DL reference signals and synchronization signals cannot adapt sufficiently fast to sudden changes on subframe timing. However, if the eNB were to wait until a start of a next subframe to take action, during the time period between when the channel becomes available and the start of the next subframe, some other competing node might grab the available channel before the eNB could make use of the channel with the UE 10. Thus, the eNB 15 would lose the channel to another node before the eNB 15 could secure the channel for use with the UE 10. With use of a reservation signal as described herein, after seeing a channel unoccupied, such as through LBT or (e)CCA for example, the eNB can transmit the reservation signal to reserve the channel until the start of a regular subframe (until the beginning of the next subframe). The eNB does not necessarily need to transmit the reservation signal to the UE. The eNB merely needs to transmit the reservation signal to reserve the channel. However, in one example embodiment the eNB would transmit the reservation signal to the UE. The benefit of the reservation signal is that LTE LAA transmission achieves subframe synchronization with a LTE PCell and other aggregated channels from the beginning of a first complete subframe. It also avoids the need for the UE to determine transmission or subframe timing from the beginning of transmission. Instead the UE can maintain synchronization with the LTE LAA SCell based on the regular reception of DL reference signals and synchronization signals. The UE may not be aware of presence of a reservation signal, and it effectively presents overhead. In a worst case type of situation, a reservation signal may have a duration of almost a full subframe without information content useful to the UE. With features as described herein, the eNB 15 may start transmitting immediately after a successful LBT to thereby occupy the channel until the beginning of the next subframe; at which point the timing is aligned with the PCell.

Features as described herein may provide an arrangement that facilitates use of a reservation signal for data communication from a LTE LAA eNB (a base station) to one or more UE. However, it should be noted that features as described herein are also applicable to use with an uplink (UL) operation from the UE to the LTE LAA eNB, and are not limited to merely a downlink (DL) operation. In one example embodiment of a DL operation, the LTE LAA equipment 15 may start transmission of a reservation signal after successful LBT (i.e. channel sensed as unoccupied, such as with use of the LBE mode of operation noted above), and may adaptively fill the remainder of the subframe from the end of the LBT until the beginning of the next subframe. This can prevent other nodes from taking use of the channel before the beginning of the next subframe.

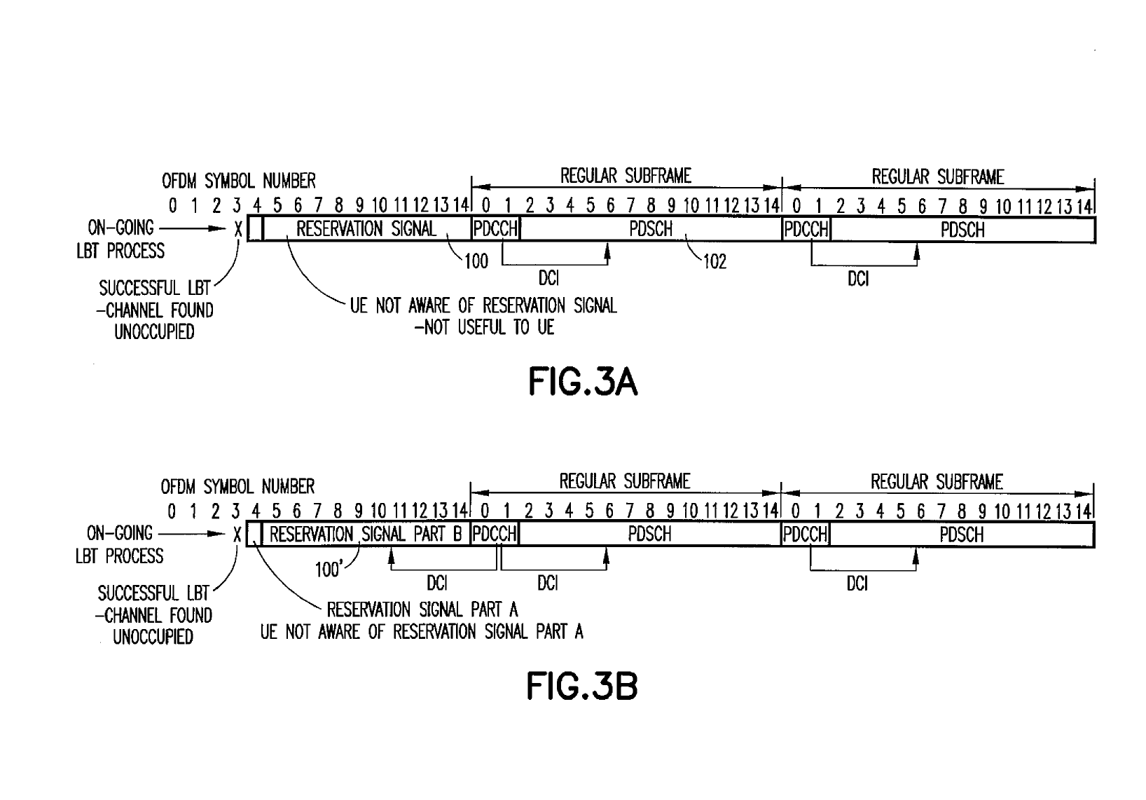

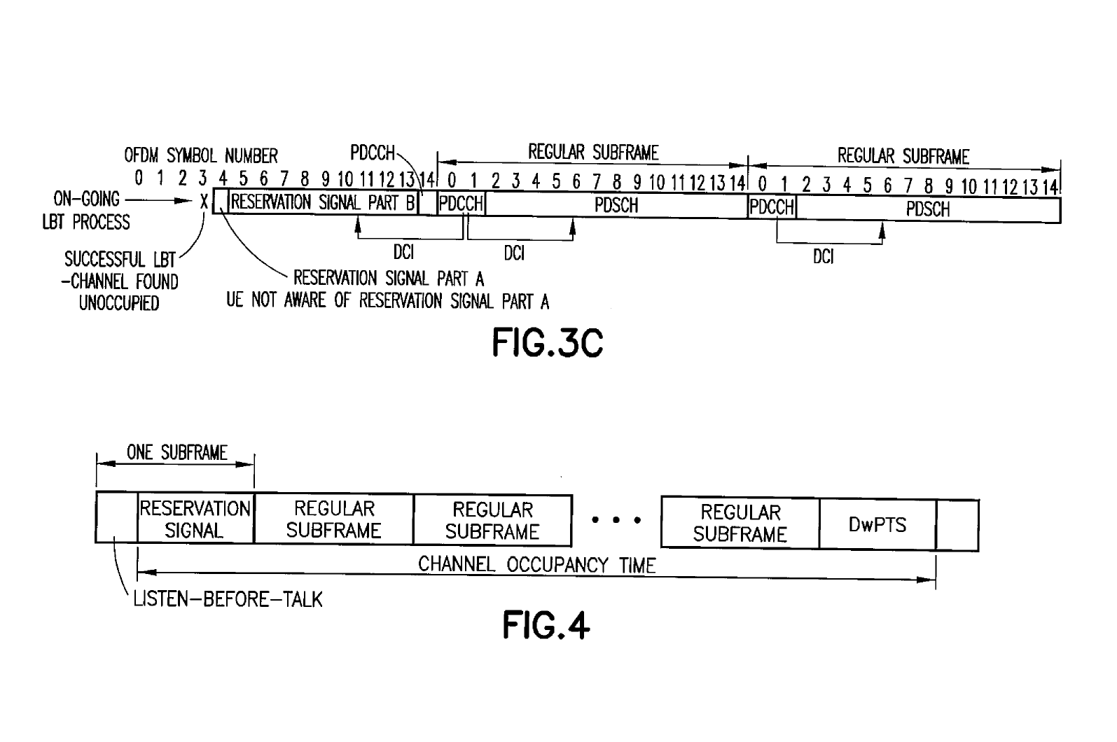

Referring also to FIG. 3A, an example of a reservation signal 100 is shown that does not contain information intended for the UE and, therefore, the UE does not need to be aware of the reservation signal transmission at all. The reservation signal 100 may have a duration from a fraction of an OFDM symbol to multiple OFDM symbols for example. If the LBT is successful, the eNB 15 starts transmitting the reservation signal 100 until the start of the following subframe 102. As the reservation signal 100 contains no useful data it basically represents considerable overhead only.

Referring also to FIG. 3B, the reservation signal 100′ may be divided into the two parts, Part A and Part B, where Part B can be used for data transmission whereas Part A contains no useful data and therefore is to be considered as overhead only. The Part A may have a duration from a fraction of an OFDM symbol to multiple OFDM symbols for example. Part B may comprise a number of normal LTE downlink OFDM symbols carrying at least data channel such as PDSCH for example. Part B may further comprise reference signals such as DMRS and/or CRS for example. As another example Part B may comprise PSS and SSS. In one example embodiment, the mapping of PDSCH symbols and reference signals to physical resource elements may follow the mapping on a corresponding normal complete subframe for the OFDM symbols contained on part B. The small differences related to mapping of PDSCH and reference signals in Part B compared to complete normal subframe may relate to PDSCH length (in OFDMA symbols) and control channel arrangement.

In an example embodiment, PDSCH transmitted on Part B may carry the same TB, to the same UE/UEs, as the PDSCH on the first complete subframe following it. For example, PDSCH transmitted on Part B may provide a different redundancy version of TB than the PDSCH on the following subframe. This type of example embodiment may be used to reduce the implementation impacts on a MAC layer for example. The dimension(s) of Part B, for example the dimensions of payload data carrying part, may be dynamically determined based on the time of successful LBT/CCA (or the start of Part A) and the fixed subframe timing.

PDSCH assignment for Part B may be carried on PDCCH (Physical Downlink Control Channel) or EPDCCH (Enhanced Physical Downlink Control Channel) of the next subframe.

DCI on the next subframe PDCCH/EPDCCH may also indicate the size of Part B on the number of OFDM symbols. In an example embodiment where Part B carries the same TB as the following subframe PDSCH, Part B PDSCH assignment may be carried on the same or separate DCI than the PDSCH assignment for the following subframe. The current dimension(s) of Part B may be indicated as part of PDSCH assignment DCI, or by a separate DCI targeted to all UEs and carried on PDCCH/EPDCCH CSS. In one example embodiment, only a few sizes of Part B may be supported to thereby simplify eNB implementation; for example 10, 7, 4, 0 symbols. DCI may be carried on the same carrier, or on another carrier such as in the PCell for example in the following subframe. The reservation signal may also carry DCI/PDCCH related to Part B itself. The DCI/PDCCH may be located in the last OFDMA symbol(s) of the Part B. An example of this is shown in FIG. 3C. Hence, DCI/PDCCH may be located at a fixed position with respect to the subframe grid.

Features as described herein may have the UE buffer samples for a subframe before the UE can check PDCCH contents. This increases the requirements for buffering as well as for processing latency. However, the required further step is not so large on top of EPDCCH buffering and processing requirements. Buffering might only be provided if the Part B is present. In case of having only a Part A type of reservation signal (without a Part B), the UE might not have buffering of the reservation signal. In case Part B is enabled, the UE may buffer the data or received signal samples) to be able to decode PDSCH or PDCCH contained in Part B.

Switching from LBT/CCA to eNB transmission is short, such as in a time scale of microseconds. For that reason, the eNB may pre-generate a Part A signal and then transmit a suitable portion of it. To ease the burden of pre-generation of a Part B signal, as well as re-generation or updating of PDCCH content on the next subframe, one example embodiment may support only a few size options for Part B, for example from 1 to 3 size options.

Any suitable method may be used for Part A signal generation such as, for example, frequency domain generation of the signal (e.g. based on pre-calculated sequences; those sequences have the desired time domain behavior), time domain generation of the signal (CAZAC sequences are examples of good sequences, where CAZAC sequences can be generated either in time or frequency), and time domain gating (cutting) applied for the sequences defined in the frequency domain.

Referring also to FIG. 4, an example method may comprise the DL transmission of an LTE LAA eNB in terms of channel occupancy. After successful LBT/(e)CCA, the LTE LAA eNB can transmit the reservation signal (containing a variable amount of Part A and Part B) until the beginning of the next regular subframe, followed by zero or multiple regular subframes and potentially by a DwPTS subframe. The channel occupancy time is, therefore, given by a combination of the length of the reservation signal(s), the number of regular DL subframes, and the DwPTS length. DwPTS may be used at the end of the channel occupancy time. The length of the DwPTS may be adapted for example, to enable maximal channel occupancy time. For example, the length of the DwPTS may depend on the length of the reservation signal (Parts A and B). Thus, the DwPTS may be consider Part C for reference herein.

To maximize the channel occupancy time, the eNB may signal to the UE whether the subframe is a normal DL subframe, or whether the subframe contains DwPTS. The UE may have prior information that the subframe is the last subframe of the channel reservation window, for example, the eNB may signal the position of channel reservation window. The signaling may also indicate the dimension(s) of the DwPTS and the number of regular DL subframes.

DwPTS may be dimensioned to maximize the channel occupancy time of the transmission burst of multiple subframes, taking into account the limit for maximum channel occupancy time under regulatory or predetermined by standards or by network configuration as well as the duration of part A and part B of the reservation signal at the beginning of transmission burst. DwPTS dimensions at the end of transmissions burst may be dynamically determined based on at least one of time of a successful CCA, time of the start of Part A, fixed subframe timing, or maximum allowed channel occupancy time. In certain circumstances, DwPTS dimensions may be dynamically determined based on time of a successful CCA or the start of Part A, fixed subframe timing and maximum allowed channel occupancy time.

Signalling may be dynamic and carried on the DCI. The same DCI may also carry corresponding PDSCH assignment for the UE, or it may be a DCI targeted to all UEs and carried on PDCCH CSS. Such a common DCI may also be signaled during previous subframes, following the eIMTA signaling framework for example. eIMTA type signaling (i.e. one which may be signaled also during previous subframes) may indicate the duration of the channel occupancy time, such as where the current reservation allocation ends for example. The transmission may end at the subframe border or alternative, there may be DwPTS at the end of current reservation window. If signaling is conveyed via PDCCH CSS (via Part B or via subframe following Part B) it may also contain an indication on the Part B. The CSS signaling might contain not just Part B length, but also a number of regular subframes and the potential length of a following DwPTS, such as the channel occupancy time for example.

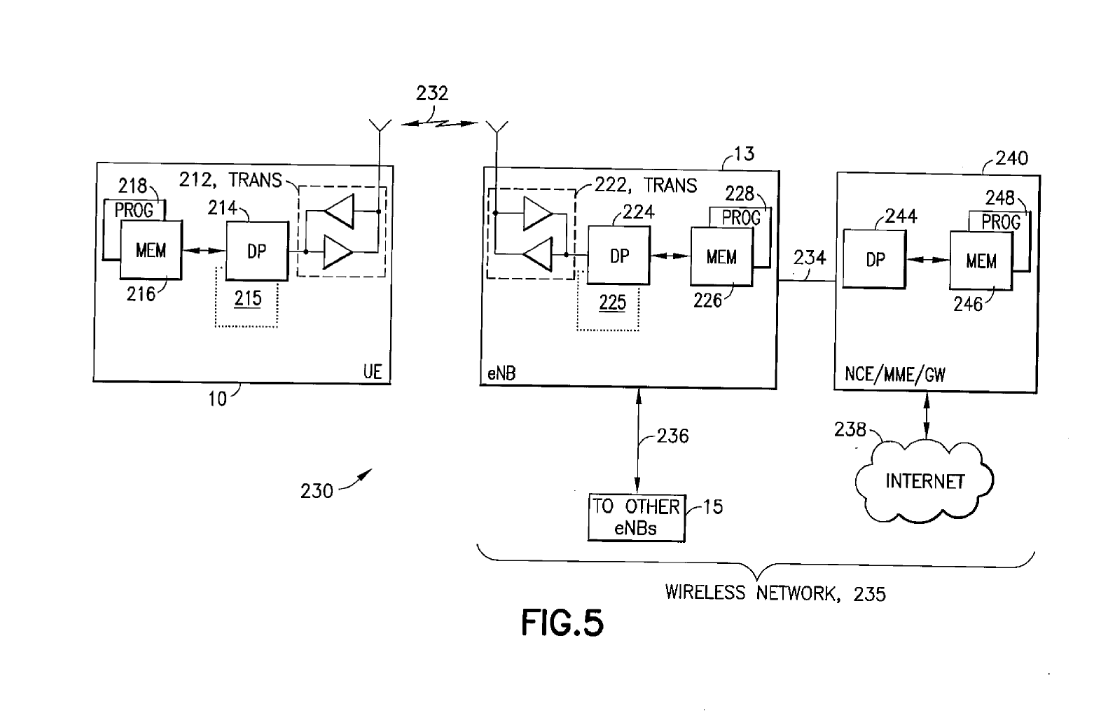

Referring also to FIG. 5, in the wireless system 230 a wireless network 235 is adapted for communication over a wireless link 232 with an apparatus, such as a mobile communication device which may be referred to as a UE 10, via a network access node, such as a Node B (base station), and more specifically an eNB 13. The network 235 may include a network control element (NCE) 240 that may include MME/S-GW functionality, and which provides connectivity with a network, such as a telephone network and/or a data communications network (e.g., the internet 238).

The UE 10 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for bidirectional wireless communications with the eNB 13 via one or more antennas.

The eNB 13 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 10 via one or more antennas. The eNB 13 is coupled via a data/control path 234 to the NCE 240. The path 234 may be implemented as an interface. The eNB 13 may also be coupled to another eNB via data/control path 236, which may be implemented as an interface.

The NCE 240 includes a controller, such as a computer or a data processor (DP) 244, a computer-readable memory medium embodied as a memory (MEM) 246 that stores a program of computer instructions (FROG) 248.

At least one of the PROGs 218, 228 and 248 is assumed to include program instructions that, when executed by the associated DP, enable the device to operate in accordance with exemplary embodiments of this invention, as will be discussed below in greater detail. That is, various exemplary embodiments of this invention may be implemented at least in part by computer software executable by the DP 214 of the UE 10; by the DP 224 of the eNB 13; and/or by the DP 244 of the NCE 240, or by hardware, or by a combination of software and hardware (and firmware). Base station 15 may have the same type of components as the base station 13.

For the purposes of describing various exemplary embodiments in accordance with this invention the UE 10 and the eNB 13 may also include dedicated processors, for example RRC module 215 and a corresponding RRC module 225. RRC module 215 and RRC module 225 may be constructed so as to operate in accordance with various exemplary embodiments in accordance with this invention.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

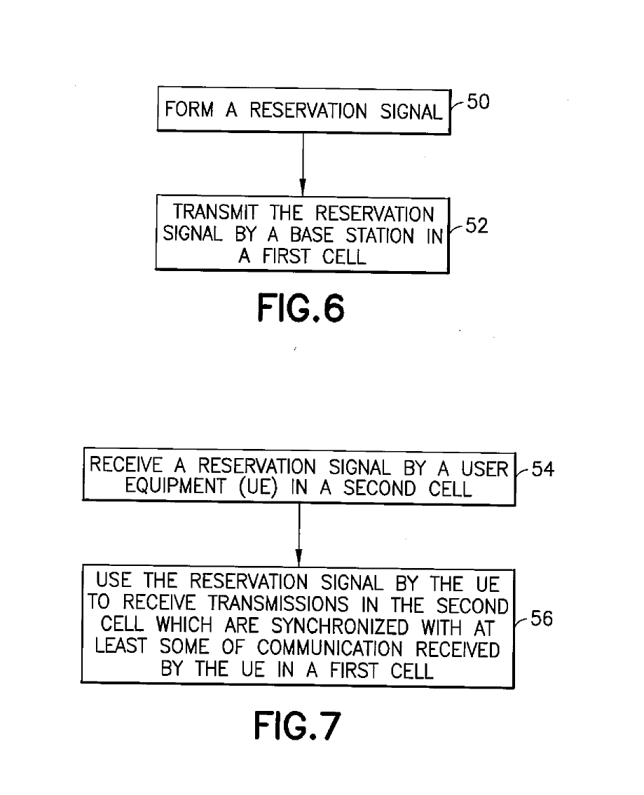

Referring also to FIG. 6, an example method may comprise forming a reservation signal as indicated by block 50 comprising a first part and a second part; and transmitting the reservation signal by a base station in a first cell on a channel as indicated by block 52, where the reservation signal uses the channel to allow for subsequent synchronization of a first communication of the base station with a user equipment (UE) on the channel in the first cell relative to a second communication with the UE in an at least partially overlapping second cell.

The reservation signal may be formed upon determining that the operating channel is unoccupied. The determining may be done based upon a Listening Before Talk (LBT)/Clear Channel Assessment (CCA) mode of operation of the base station, including beside others a Load Based Equipment (LBE) mode of operation. Transmitting the reservation signal and the first communication may be in an unlicensed band configured to allow for a licensed-assisted carrier aggregation operation with the second communication transmitted in a licensed band. Transmitting the reservation signal may be delayed until the base station identifies a channel to be unoccupied for a Listen Before Talk (LBT) operation. Forming the reservation signal may comprise the reservation signal including a first part (Part A) and a subsequent second part (Part B). Both the first part and the second part are configured to reserve a channel between the base station and the User Equipment (UE), but the first part does not need to contain useful data for the UE to use and the second part may or may not contain useful data for the UE to use. The second part (Part B) may comprise at least one of Long Term Evolution (LTE) downlink Orthogonal Frequency Division Multiplexing (OFDM) symbols carrying Physical Downlink Shared Channel (PDSCH), Demodulation Reference Signal (DMRS), Cell Specific Reference Signal (CRS). The PDSCH of Part B might contain information of the same Transport Blocks (TB) as a PDSCH on a first following complete, regular subframe. However, as noted above, this is only one type of option. In another example embodiment, the PDSCH transmitted on Part B may provide a different redundancy version of TB than the PDSCH on the following subframe. The method may further comprise mapping symbols of the PDSCH. The reservation signal might only be mapped to the beginning of incomplete subframes. When there is a complete subframe, then a regular subframe is transmitted with no reservation signal. The Physical Downlink Control Channel (PDCCH) may be located in one or more last Orthogonal Frequency Division Multiplexing (OFDM) symbols of the reservation signal. The Physical Downlink Control Channel (PDCCH) may be located at a fixed position with respect to a subframe grid. A dimension of at least a part of the reservation signal may be dynamically determined based upon time of successful Clear Channel Assignment (CCA) or the start of a prior part of the reservation signal, and fixed subframe timing. The method may further comprise signaling by the base station to the User Equipment (UE) whether the subframe or the following subframes is/are a normal downlink (DL) subframe, and/or whether the (last) subframe contains only a Downlink Pilot Time Slot (DwPTS). The method may further comprise the base station indicating a dimensioning of the potential Downlink Pilot Time Slot (DwPTS). The method may further comprise dynamically determining dimensions of the Downlink Pilot Time Slot (DwPTS) based upon at least one of time of a successful Clear Channel Assignment (CCA) or a start of the reservation signal, fixed subframe timing, and maximum allowed channel occupancy time.

An example apparatus (such as 13 for example) may comprise at least one processor; and at least one non-transitory memory including computer program code, the at least one memory and the computer program code configured to, with the at least one processor, cause the apparatus to form a reservation signal comprising a first part and a second part; and transmit the reservation signal in a first cell on a channel, where the reservation signal uses the channel to allow for subsequent synchronization of communication of the apparatus with a user equipment (UE) in the first cell relative to communication with the UE in a second cell.

A non-transitory program storage device (such as 226 for example) may be provided, readable by a machine, tangibly embodying a program of instructions executable by the machine for performing operations, the operations comprising forming a reservation signal comprising a first part and a second part; and transmitting the reservation signal by a base station in a first cell on a channel, where the reservation signal uses the channel to allow for subsequent synchronization of communication of the base station with a user equipment (UE) in the first cell relative to communication with the UE in a second cell.

Referring also to FIG. 6, an example method may comprise in a user equipment (UE) having communication in a first cell using a licensed spectrum, receiving a reservation signal on a channel in a second cell as indicated by block 54, where the reservation signal comprises a first part and a second part; and using the reservation signal by the UE to subsequently receive a transmission on the channel in the second cell for synchronizing communication in the second cell with at least some of the communication received by the UE in the first cell as indicated by block 56.

The reservation signal may be received in an unlicensed spectrum in the second cell. The reservation signal may include a first part (Part A) and a subsequent second part (Part B), where the first part is configured to reserve a channel between a base station of the second cell and the User Equipment (UE). The second part (Part B) may comprise at least one of Long Term Evolution (LTE) downlink Orthogonal Frequency Division Multiplexing (OFDM) symbols carrying the Physical Downlink Shared Channel (PDSCH), Demodulation Reference Signal (DMRS), Common Reference Signal (CRS), a same Transport Block (TB) as a PDSCH on a first following complete subframe. The method may further comprise identifying the Physical Downlink. Control Channel (PDCCH) located at a fixed position with respect to a subframe grid. The method may further comprise identifying the Physical Downlink Control Channel (PDCCH) located in one or more last Orthogonal Frequency Division Multiplexing (OFDM) symbols of the reservation signal. The method may further comprise receiving an indication from a base station that the reservation signal contains only a Downlink Pilot Time Slot (DwPTS) and an indication of a dimensioning of the Downlink Pilot Time Slot (DwPTS). The method may further comprise dynamically determining dimensions of the Downlink Pilot Time Slot (DwPTS) based upon at least one of time of a successful Clear Channel Assignment (CCA) or a start of the reservation signal, fixed subframe timing, and maximum allowed channel occupancy time.

An example apparatus, such as the User Equipment 10 for example, may comprise at least one processor; and at least one non-transitory memory including computer program code, the at least one memory and the computer program code configured to, with the at least one processor, cause the apparatus to use a reservation signal received on a channel in a second cell to subsequently a receive transmission in the second cell for synchronizing communication in the second cell with at least some communications received by the apparatus in a first cell.

A non-transitory program storage device may be provided, such as 216 for example, readable by a machine, tangibly embodying a program of instructions executable by the machine for performing operations, the operations comprising in a user equipment (UE) having communication in a first cell using a licensed spectrum, receiving a reservation signal on a channel in a second cell, where the reservation signal comprises a first part and a second part; and using the reservation signal by the UE to subsequently receive transmissions on the channel in the second cell for synchronizing communication in the second cell with at least some of the communication received by the UE in the first cell.

Any combination of one or more computer readable medium(s) may be utilized as the memory for storing the software. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An example embodiment may be provided in an apparatus comprising means for forming a reservation signal comprising a first part and a second part; and means for transmitting the reservation signal by a base station in a first cell on a channel, where the reservation signal uses the channel to allow for subsequent synchronization of a first communication of the base station with a user equipment (UE) on the channel in the first cell relative to a second communication with the UE in an at least partially overlapping second cell.

An example embodiment may be provided in an apparatus comprising, in a user equipment (UE) having communication in a first cell using a licensed spectrum, means for receiving a reservation signal in a second cell on a channel, where the reservation signal comprises a first part and a second part; and means for using the reservation signal by the UE to subsequently receive a transmission in the second cell on the channel for synchronizing communication in the second cell with at least some of the communication received by the UE in the first cell.

An example method may comprise forming a reservation signal; and transmitting the reservation signal by a base station in a first cell on a channel during a portion of a first subframe until start of a next following subframe, where the reservation signal occupies the channel until the start of the next following subframe to reserve the channel for subsequent use between the base station and a User Equipment (UE), where the portion is less than the entire first subframe.

The reservation signal may be formed based upon a successful Listen Before Talk (LBT) operation sensing the channel to be unoccupied. Transmitting the reservation signal may be in an unlicensed band configured to allow for a subsequent licensed-assisted carrier aggregation operation with a communication transmitted in a licensed band. Transmitting the reservation signal may be delayed until the base station identifies the channel as being clear in a Listen Before Talk (LBT) operation. A second part of the reservation signal may comprise downlink Orthogonal Frequency Division Multiplexing (OFDM) symbols carrying Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on a first following subframe. The PDSCH transmitted on the second part may provide a different redundancy version of a transport block than a PDSCH on the next following subframe. Dimension(s) of a second part of the reservation signal may be indicated to a user equipment (UE) as part of a Physical Downlink Shared Channel (PDSCH) assignment Downlink Control Information (DCI), or by a separate DCI targeted to multiple UEs and carried on a Physical Downlink Control Channel (PDSCH) Common Search Space (CSS). Sizes of a second part of the reservation signal may be one of a number of predetermined sizes which is less than all symbols of the second part. The method may further comprise mapping symbols of at least one of the Physical Downlink Shared Channel (PDSCH), Demodulation Reference Signal (DMRS), Cell Specific Reference Signal (CRS), on a second part of the reservation signal to same physical resource elements as on a corresponding Orthogonal Frequency Division Multiplexing (OFDM) symbol of a normal complete subframe. A Physical Downlink Control Channel (PDCCH) may be located in one or more last Orthogonal Frequency Division Multiplexing (OFDM) symbols of a second part of the reservation signal. A Physical Downlink Control Channel (PDCCH) may be located at a fixed position with respect to a subframe grid of a second part of the reservation signal. A dimension of at least a part of the reservation signal may be dynamically determined based upon time of successful Clear Channel Assignment (CCA) or the start of a prior part of the reservation signal, and fixed subframe timing. The method may further comprise signaling by the base station to a User Equipment (UE) whether a last subframe of a channel reservation window is a normal downlink (DL) subframe, or whether the subframe contains a Downlink Pilot Time Slot (DwPTS). The method may further comprise the base station indicating a dimensioning of the Downlink Pilot Time Slot (DwPTS). The method may further comprise dynamically determining dimensions of the Downlink Pilot Time Slot (DwPTS) based upon at least one of time of a successful Clear Channel Assignment (CCA) or a start of a first or a second part of the reservation signal, fixed subframe timing, and maximum allowed channel occupancy time.

An example apparatus may comprise at least one processor; and at least one non-transitory memory including computer program code, the at least one memory and the computer program code configured to, with the at least one processor, cause the apparatus to: form a reservation signal; and transmit the reservation signal in a first cell on a channel during a portion of a first subframe until start of a next following subframe, where the reservation signal occupies the channel until the start of the next following subframe to reserve the channel for subsequent use between the apparatus and a User Equipment (UE), where the portion is less than the entire first subframe.

The at least one memory, the computer program code and the processor may be configured to form the reservation signal based upon a successful Listen Before Talk (LBT) operation sensing the channel to be unoccupied. The at least one memory, the computer program code and the processor may be configured to transmit the reservation signal in an unlicensed band configured to allow for a subsequent licensed-assisted carrier aggregation operation with a communication transmitted in the second cell on a licensed band. The at least one memory, the computer program code and the processor may be configured to delay transmit of the reservation signal until the apparatus identifies the channel as being clear in a Listen Before Talk (LBT) operation. The at least one memory, the computer program code and the processor may be configured to form the reservation signal with a first part configured to reserve the channel between the apparatus and a User Equipment (UE) and a second part configured to reserve the channel between the apparatus and the User Equipment (UE) and provide data to the User Equipment (UE). The at least one memory, the computer program code and the processor may be configured to provide the reservation signal with a second part which includes downlink Orthogonal Frequency Division Multiplexing (OFDM) symbols carrying at least one of Downlink Pilot Time Slot (DwPTS), Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on a first following subframe. The at least one memory, the computer program code and the processor may be configured to provide a PDSCH transmitted on a second part of the reservation signal which provides a different redundancy version of a transport block than a PDSCH on the next following subframe. The at least one memory, the computer program code and the processor may be configured to provide a dimension(s) of a second part of the reservation signal indicated as part of a PDSCH assignment Downlink Control Information (DCI), or by a separate DCI targeted to multiple UEs and carried on a PDCCH Common Search Space (CSS). The at least one memory, the computer program code and the processor may be configured to provide a size of the second part as one of a number of predetermined sizes which are less than all symbols of the second part. The at least one memory, the computer program code and the processor may be configured to are configured to map symbols of at least one of Physical Downlink Shared Channel (PDSCH), Demodulation Reference Signal (DMRS), Cell Specific Reference Signal (CRS), on a second part of the reservation signal to same physical resource elements as on a corresponding Orthogonal Frequency Division Multiplexing (OFDM) symbol of a normal complete subframe.

An example embodiment may be provided in a non-transitory program storage device readable by a machine, tangibly embodying a program of instructions executable by the machine for performing operations, the operations comprising: forming a reservation signal; and transmitting the reservation signal by a base station in a first cell on a channel during a portion of a first subframe until start of a next subframe, where the reservation signal occupies the channel until the start of the next subframe to reserve the channel for subsequent use between the base station and the User Equipment (UE), where the portion is less than the entire first subframe.

An example embodiment may be provided in an apparatus comprising means for forming a reservation signal; and means for transmitting the reservation signal by a base station in a first cell on a channel during a portion of a first subframe until start of a next subframe, where the reservation signal occupies the channel until the start of the next subframe to reserve the channel for subsequent use between the base station and a User Equipment (UE), where the portion is less than the entire first subframe.

An example embodiment may be provided in an apparatus comprising: in a user equipment (UE) having communication in a first cell using a licensed spectrum, means for receiving a reservation signal in a second cell on a channel, where the reservation signal comprises a first part and a second part; and means for using the reservation signal by the UE to subsequently receive a transmission in the second cell on the channel for synchronizing communication in the second cell with at least some of the communication received by the UE in the first cell.

Certain scenarios may appear after LAA. This may include co-primary sharing between operators, flexible spectrum usage, etc. LAA may be enough for those scenarios. Even though features have been described herein from the viewpoint of LAA, it is equally valid for other co-existence scenarios such as, for example,:
Licensed Shared Access (LSA). LSA is a spectrum sharing concept enabling access to spectrum that is identified for IMT, but not cleared for IMT deployment. Focused on bands subject to harmonization and standardized by 3GPP (2.3 GHz in EU & China, 1.7 GHz and 3550-3650 MHz in US).
Co-primary sharing is another example scenario. Co-primary sharing refers to spectrum sharing where several primary users (operators) share the spectrum dynamically or semi-statically. Suitable spectrum may be, for example, for small cells exists at 3.5 GHz. Spectrum sharing between operators will happen if regulators enforce it and/or operators need it.

An example method may comprise forming a reservation signal comprising a first part and a second part; and transmitting the reservation signal by a base station in a first cell on a channel during a portion of a first subframe until start of a next following subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example embodiment may be provided in an apparatus comprising at least one processor; and at least one non-transitory memory including computer program code, the at least one memory and the computer program code configured to, with the at least one processor, cause the apparatus to: form a reservation signal comprising a first part and a second part; and transmit the reservation signal in a first cell on a channel during a portion of a first subframe until start of a next following subframe, where the first part is configured to reserve the channel between the apparatus and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example embodiment may be provided in a non-transitory program storage device readable by a machine, tangibly embodying a program of instructions executable by the machine for performing operations, the operations comprising: forming a reservation signal comprising a first part and a second part; and transmitting the reservation signal by a base station in a first cell on a channel during a portion of a first subframe until start of a next subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example method may comprise, in a user equipment (UE) having communication in a first cell using a licensed spectrum, receiving a reservation signal in a second cell on a channel during a portion of a first subframe until start of a next following subframe, where the reservation signal comprises a first part and a second part; and using the second part of the reservation signal by the UE, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example method may comprise receiving an assignment for a Physical Downlink Shared Channel (PDSCH) on a second part of a reservation signal, where the reservation signal comprises a first part and the second part, where the second part comprises downlink Orthogonal Frequency Division Multiplexing (OFDM) symbols carrying Physical Downlink Shared Channel (PDSCH) and at least one of Demodulation Reference Signal (DMRS), Cell Specific Reference Signal (CRS), Physical Downlink Control Channel (PDCCH), or a same Transport Block (TB) as a PDSCH on a next following subframe; and receiving PDSCH on the second part of the reservation signal during a portion of a first subframe until start of a next following subframe, where the portion is less than the entire first subframe.

An example embodiment may be provided in an apparatus comprising at least one processor; and at least one non-transitory memory including computer program code, the at least one memory and the computer program code configured to, with the at least one processor, cause the apparatus to: with the apparatus having communication in a first cell using a licensed spectrum, receive a reservation signal in a second cell on a channel during a portion of a first subframe until start of a next following subframe, where the reservation signal comprises a first part and a second part; and use the second part of the reservation signal by the apparatus, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example embodiment may be provided in a non-transitory program storage device readable by a machine, tangibly embodying a program of instructions executable by the machine for performing operations, the operations comprising: in a user equipment (UE) having communication in a first cell using a licensed spectrum, receiving a reservation signal on a channel in a second cell, where the reservation signal comprises a first part and a second part; and using the second part of the reservation signal by the UE, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example embodiment may be provided in an apparatus comprising: means for forming a reservation signal comprising a first part and a second part; and means for transmitting the reservation signal by a base station in a first cell on a channel during a portion of a first subframe until start of a next subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

An example embodiment may be provided in an apparatus comprising: in a user equipment (UE) having communication in a first cell using a licensed spectrum, means for receiving a reservation signal in a second cell on a channel during a portion of a first subframe until start of a next following subframe, where the reservation signal comprises a first part and a second part; and means for using the second part of the reservation signal by the UE , where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-49. (canceled)

50. An apparatus comprising:
at least one processor; and
at least one non-transitory memory including computer program code, the at least one memory and the computer program code configured to, with the at least one processor, cause the apparatus to:
with the apparatus having communication in a first cell using a licensed spectrum, receive a reservation signal in a second cell on a channel during a portion of a first subframe until start of a next following subframe, where the reservation signal comprises a first part and a second part; and
use the second part of the reservation signal by the apparatus, where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

51. An apparatus as in claim 50 where the reservation signal is received in an unlicensed spectrum in the second cell.

52. An apparatus as in claim 50 where the at least one memory, the computer program code and the processor are configured to use the first part of the reservation signal to reserve the channel between a base station of the second cell and the apparatus.

53. An apparatus as in claim 50 where the at least one memory, the computer program code and the processor are configured to receive signaling indicating whether a last subframe of a channel occupancy is a normal downlink (DL) subframe, or whether the subframe contains a Downlink Pilot Time Slot (DwPTS).

54. An apparatus as in claim 53 where the at least one memory, the computer program code and the processor are configured to determine dimensions of the Downlink Pilot Time Slot (DwPTS) based upon at least one of time of a successful Clear Channel Assignment (CCA) or a start of the first or the second part of the reservation signal, fixed subframe timing, and maximum allowed channel occupancy time.

55. An apparatus as in claim 50 where the at least one memory, the computer program code and the processor are configured to receive an indication from a base station in the second cell that the reservation signal contains only a Downlink Pilot Time Slot (DwPTS) and an indication of a dimensioning of the Downlink Pilot Time Slot (DwPTS).

56. An apparatus comprising:
at least one processor; and
at least one non-transitory memory including computer program code, the at least one memory and the computer program code configured to, with the at least one processor, cause the apparatus to:
form a reservation signal comprising a first part and a second part; and
transmit the reservation signal in a first cell on a channel during a portion of a first subframe until start of a next following subframe, where the first part is configured to reserve the channel between the apparatus and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

57. An apparatus as in claim 56 where the at least one memory, the computer program code and the processor are configured to form the reservation signal based upon a successful Listen Before Talk (LBT) operation sensing the channel to be unoccupied.

58. An apparatus as in claim 56 where the at least one memory, the computer program code and the processor are configured to transmit the reservation signal in an unlicensed band and is configured to allow for a subsequent licensed-assisted carrier aggregation operation with a communication transmitted in the second cell on a licensed band.

59. An apparatus as in claim 56 where the at least one memory, the computer program code and the processor are configured to delay transmit of the reservation signal until the apparatus identifies the channel as being clear in a Listen Before Talk (LBT) operation.

60. An apparatus as in claim 56 where the at least one memory, the computer program code and the processor are configured to provide the PDSCH transmitted on the second part of the reservation signal with a different transport block or a different redundancy version of a transport block than the PDSCH on the next following subframe.

61. An apparatus as in claim 56 where the at least one memory, the computer program code and the processor are configured to map symbols of at least one of Physical Downlink Shared Channel (PDSCH), Demodulation Reference Signal (DMRS), Cell Specific Reference Signal (CRS), on the second part of the reservation signal to same physical resource elements as on a corresponding Orthogonal Frequency Division Multiplexing (OFDM) symbol of a normal complete subframe.

62. An apparatus as in claim 56 where the Physical Downlink Control Channel (PDCCH) is located at a fixed position with respect to a subframe grid of the second part of the reservation signal.

63. An apparatus as in claim 56 where the at least one memory, the computer program code and the processor are configured to signal to the User Equipment (UE) whether a last subframe of a channel occupancy is a normal downlink (DL) subframe, or whether the subframe contains a Downlink Pilot Time Slot (DwPTS).

64. An apparatus as in claim 63 where the at least one memory, the computer program code and the processor are configured to indicate a dimensioning of the Downlink Pilot Time Slot (DwPTS).

65. An apparatus as in claim 64 where the at least one memory, the computer program code and the processor are configured to determine dimensions of the Downlink Pilot Time Slot (DwPTS) based upon at least one of time of a successful Clear Channel Assignment (CCA) or a start of the first or the second part of the reservation signal, fixed subframe timing, and maximum allowed channel occupancy time.

66. A method comprising:
forming a reservation signal comprising a first part and a second part; and
transmitting the reservation signal by a base station in a first cell on a channel during a portion of a first subframe until start of a next following subframe, where the first part is configured to reserve the channel between the base station and a user equipment (UE), where the second part comprises downlink Orthogonal Frequency Division Multiplexing (OFDM) symbols carrying at least one of Physical Downlink Shared Channel (PDSCH), Demodulation Reference Signal (DMRS), Cell Specific Reference Signal (CRS), Physical Downlink Control Channel (PDCCH), or a same Transport Block (TB) as a PDSCH on the next following subframe, and the portion is less than the entire first subframe.

67. A method as in claim 66 where the reservation signal is formed based upon a successful Listen Before Talk (LBT) operation sensing the channel to be unoccupied.

68. A method as in claim 66 where transmitting the reservation signal is in an unlicensed band and is configured to allow for a subsequent licensed-assisted carrier aggregation operation with a communication transmitted in a licensed band.

69. A method as in claim 66 where transmitting the reservation signal is delayed until the base station identifies the channel as being clear in a Listen Before Talk (LBT) operation.
